(19) United States
(12) Patent Application Publication
(10) Pub. No.: US 2026/0197069 A1
(43) Pub. Date: Jul. 9, 2026

(54) AUTONOMOUS BEAM REFINEMENT

(71) Applicant: Sony Group Corporation, Tokyo (JP)

(72) Inventors: Erik BENGTSSON, Eslöv (SE); Fredrik RUSEK, Eslöv (SE); Olof ZANDER, Södra Sandby (SE)

(21) Appl. No.: 19/130,855

(22) PCT Filed: Dec. 1, 2023
(86) PCT No.: PCT/EP2023/083858

§ 371 Date: May 16, 2025

(30) Foreign Application Priority Data
Dec. 5, 2022 (SE) 2251413-7

(51) Int. Cl. H04B 7/06; H04W 16/26

(52) U.S. Cl. CPC H04B 7/0696; H04W 16/26

(57) ABSTRACT

Examples provide a method of operating a coverage enhancing device (CED) (602) is proposed, wherein the CED (602) provides reconfigurable filters for incident signals received along an input spatial direction on a radio channel and transmitted as outgoing signal into an output spatial directions, the method comprising obtaining a message (614) indicative of an initial filter to be applied by the CED (602), and obtaining, in particular from an operator node (ON), a message (615) triggering the CED (602) to enter an autonomous filter optimization mode (622). Further examples provide a method of operating an operator node, a CED and an operator node.

### TECHNICAL FIELD

Various examples generally relate to communicating between communication nodes using coverage enhancing devices.

### BACKGROUND

In order to increase a coverage area for wireless communication, it is envisioned to use coverage enhancing devices (CEDs), particularly reconfigurable relaying devices (RRD), more particularly, reconfigurable reflective devices. Reconfigurable reflective devices are sometimes also referred to as reflecting large intelligent surfaces (LISs). Huang, C., Zappone, A., Alexandropoulos, G. C., Debbah, M., & Yuen, C. Large intelligent surfaces for energy efficiency in wireless communication available at arXiv:1810.06934v1.

In some scenarios, CED may comprise Network Controlled Repeaters (NCR) as introduced in 3GPP Rel 18.

In general, commonalities between a RIS (Reflective Intelligent Surface), NCR lays in that they use large arrays with antennas and therefore needs to be configured with spatial filters (i.e. beam forming), which requires some algorithm to determine said configurations. To be generic, we use the neutral term coverage enhancement devices (CED) for both RISs and NCRs.

The CED provides reconfigurable filters for incident signals received along an input spatial direction on a radio channel and transmitted as outgoing signals into an output spatial direction. A CED or RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a radio channel are accepted and an output spatial direction into which the incident signals are transmitted, in particular reflected, can be reconfigured by changing a phase relationship between the antennas. Radio channel may refer to a radio channel specified by the 3GPP standard. In particular, the radio channel may refer to a physical radio channel. The radio channel may offer several time/frequency-resources for communication between different communication nodes of a communication system.

An access node (AN) may transmit signals to a wireless communication device (user equipment, UE) via a CED. The CED may receive the incident signals from an input spatial direction and emit the incident signals in an output spatial direction to the UE. The AN may transmit the signals using a beam directed to the CED.

In addition or alternatively to reconfiguring an input spatial direction of the CED from which incident signals on a radio channel are accepted and an output spatial direction into which the incidents signals are transmitted, reconfiguring may involve changing a beamwidth to be used for transmitting the incident signal as outgoing signal into the output spatial direction and/or changing a beamwidth to be used for accepting the incident signals.

Wider beamwidths may be advantageous in high mobility cases, i.e. in cases where the UE changes its position comparably fast. Narrower beamwidths may be less prone to interference problems, in particular interference problems due to multiple reflections.

Moreover, different beamwidths may be associated with different equivalent isotropically radiated power (EIRP) levels of the transmitted outgoing signal. A narrower beamwidth with the same transmitted power as a wider beam will lead to a higher EIRP level.

In some scenarios, the CED may be controlled by the AN. In other scenarios, the CED may be controlled by the UE. Both the AN and the UE may be considered as communication nodes of a wireless communication network. The node controlling the CED may be called operator node (ON).

Typically, the ON controls the CED to toggle through different filters, wherein for each filter a pilot signal is communicated between the communication nodes communicating via the CED. This may be called a beam sweep. The strongest of the measured pilot signals is then associated with the best filter, which is then to be applied by the CED. In some scenarios, the filters to be applied by the CED for the beam sweep may be specified in a codebook. In order to keep the time required for the beam sweep reasonably short and to allow for data communication between the communication nodes, only a limited number of different filters can be tested. This may imply that a working but not optimal filter is selected to be applied by the CED.

### SUMMARY

Accordingly, there may be a need for improving communication between communication nodes of a network via a CED.

Said need is addressed with the subject-matter of the independent claims. Advantageous embodiments are described in the dependent claims.

Examples disclose a method of operating a CED, wherein the CED provides reconfigurable filters for incident signals received along an input spatial direction on a radio channel and transmitted as outgoing signals into an output spatial direction, the method comprising obtaining a message indicative of an initial filter to be applied by the CED, obtaining a message triggering the CED to enter an autonomous filter optimization mode.

Further examples disclose a method of operating an operator node, ON, wherein the operator node is configured for controlling a CED, wherein the CED provides reconfigurable filters for incident signals received along an input spatial direction on a radio channel and transmitted as outgoing signals into an output spatial direction, the method comprising providing, to the CED, a message triggering the CED to enter an autonomous filter optimization node.

Some examples disclose a CED comprising reconfigurable filters for incident signals received along an input spatial direction on a radio channel and transmitted as outgoing signals into an output spatial direction, wherein the CED comprises control circuitry configured for performing the aforementioned method.

Further examples disclose an ON, wherein the ON is configured for controlling a CED, wherein the CED provides reconfigurable filters for incident signals received along an input spatial direction on a radio channel and transmitted as outgoing signals into an output spatial direction, wherein the ON comprises control circuitry for performing the aforementioned method.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at a transmitter node of the communication system and further schematically illustrates a CED towards which one of the multiple transmit beams is directed according to various examples.

FIG. 4 schematically illustrates details with respect to a CED.

FIG. 5 schematically illustrates a scenario benefitting from a CED.

FIG. 6 illustrates signaling between an operator node (ON) and a CED.

FIG. 7 illustrates a method of operating a communication network.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node (AN), in particular, a base station (BS), of the RAN, and the one or more receiver nodes can be implemented by terminals (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios, e.g., uplink (UL) communication and/or sidelink communication.

### Communication Via CEDs

According to various examples, the transmitter node can communicate with at least one of the receiver nodes via one or more CEDs.

The CEDs may include an antenna array. The CEDs may include a meta-material surface. In examples, the CEDs may include a reflective antenna array (RAA).

There are many schools-of-thought for how CEDs should be integrated into 3GPP-standardized RANs.

In an exemplary case, the NW operator has deployed the CEDs and is, therefore, in full control of the CEDs' operations. The UEs, on the other hand, may not be aware of the presence of any CED, at least initially, i.e., it is transparent to a UE whether it communicates directly with the AN or via the CEDs. The CEDs essentially function as a coverage-extender of the AN. The AN may have established control links with the CEDs.

According to another exemplary case, it might be a private user or some public entity that deploys the CEDs. Further, it may be that the UE, in this case, controls the CEDs' operations. The AN, on the other hand, may not be aware of the presence of any CED and, moreover, may not have control over it/them whatsoever. The UE may gain awareness of the presence of a CED by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the CED. It is also possible that the UE gains awareness of the presence of a CED using UWD (Ultra wideband) communication. Using UWB may offer better time resolution due to the wider bandwidth compared to other radio technologies.

The two exemplary cases described above are summarized in TAB. 1 below.

TABLE 1
Scenarios for CED integration into cellular NW

| Scenario | Description | Explanation |
|---|---|---|
| A | AN-CED control link | AN controls the CED and/or |
| | | can obtain information from |
| | | the CED. A control link is |
| | | established between the AN |
| | | and the CED. |
| B | UE-CED control link | UE controls the CED and/or |
| | | can obtain information from |
| | | the CED. A control link is |
| | | established between the UE |
| | | and the CED. |

Hereinafter, techniques will be described which facilitate communication between a transmitter node—e.g., an AN—and one or more receiver nodes—e.g., one or more UEs—using a CED.

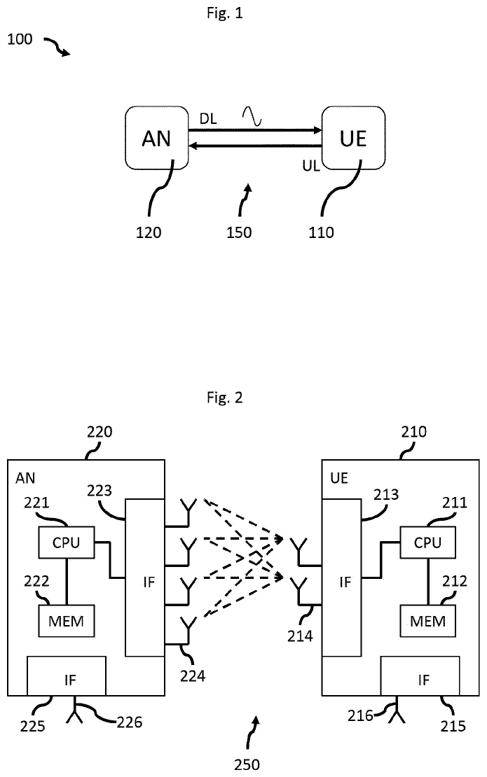

FIG. 1 schematically illustrates a communication system 100. The communication system 100 includes two nodes 110, 120 that are configured to communicate with each other via a radio channel 150. In the example of FIG. 1, the node 120 is implemented by an access node (AN) and the node 110 is implemented by a UE. The AN 120 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by an AN 120 of a cellular NW and a UE 110.

As illustrated in FIG. 1, there can be DL communication, as well as UL communication. Some examples described herein focus on the DL communication, but similar techniques may be applied to UL communication and/or sidelink communication. FIG. 2 illustrates details with respect to the AN 220. The AN 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the AN 220 and the UE 210 on the radio channel 250. The AN 220 includes an interface 223 that can access and control multiple antennas 224. Likewise, the UE 210 includes an interface 213 that can access and control multiple antennas 214.

The UE 210 comprises a further interface 215 that can access and control at least one antenna 216 to transmit or receive a signal on an auxiliary radio channel different from the radio channel 250. Likewise, the AN 220 may comprise an additional interface 225 that can access and control at least one antenna 226 to transmit or receive a signal on the or a further auxiliary radio channel different from the radio channel. In general, the interface 225 may also be a wired interface. It may also be possible that the interface 225 is a wired or wireless optical interface. If wireless, the auxiliary radio channel may use in-band signaling or out-of-band signaling. The radio channel and the auxiliary radio channel may be offset in frequency. The auxiliary radio channel may be at least one of a Bluetooth radio channel, a WiFi channel, or an ultra-wideband radio channel. Methods for determining an angle of arrival may be provided by a communication protocol associated with the auxiliary radio channel. For example, methods for determining an angle of arrival may be provided by a Bluetooth radio channel.

While the scenario of FIG. 2 illustrates the antennas 224, 226 being coupled to the AN 220, as a general rule, it would be possible to employ transmit-receive points (TRPs) that are spaced apart from the AN 220.

The interfaces 213, 223 can each include one or more transmitter (TX) chains and one or more receiver (RX) chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 214, 224. Thereby, the AN 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Energy may also be focused to a specific point (or limited volume) at a specific direction and a specific distance of the transmitter. Thereby, a data stream may be directed in multiple spatial directions and/or to multiple specific points. The data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

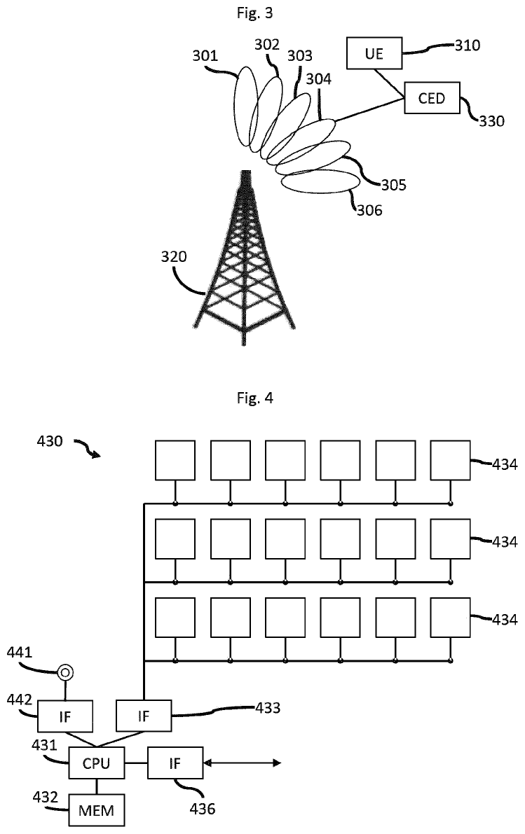

FIG. 3 illustrates DL TX beams 301-306 used by the AN 320. Here, the AN 320 activates the beams 301-306 on different resources (e.g., different time-frequency resources, and/or using orthogonal codes/precoding) such that the UE 310 can monitor for respective signals transmitted on the DL TX beams 301-306.

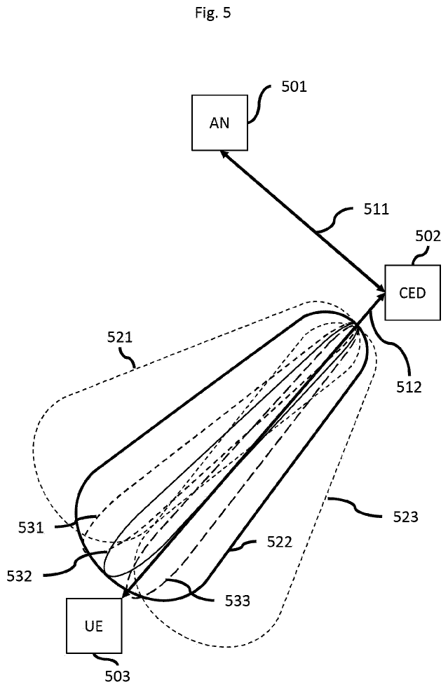

It is possible that the AN 320 transmits signals to the UE 310 via a CED 330. In the scenario of FIG. 3, the downlink transmit beam 304 is directed towards the CED 330. Thus, whenever the AN 320 transmits signals to the UE 310 using the downlink transmit beam 304—e.g., a respective block of a burst transmission-, a spatial filter is provided by the CED 330. The spatial filter is associated with a respective spatial direction into which the incident signals are then selectively reflected by the CED 330. Details with respect to the CED 330 are illustrated in connection with FIG. 4.

FIG. 4 illustrates aspects in connection with the CED 430. The CED 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The CED 430 thus provides coverage extension by reflection of radio-frequency (RF) signals. A translation to the baseband may not be required. This is different to, e.g., decode-and-forward repeaters or regenerative functionality. The antennas 434 may induce an amplitude shift by attenuation. In some examples, the antennas 434 may provide forward amplification with or without translation of signals transmitted on the radio channel to the baseband. In some examples, the CEDs may be configurable to shift power from one polarization to the orthogonal polarization. The antennas 434 may amplify and forward the signals.

The CED 430 includes an antenna interface 433, which controls an array of antennas 434; a processor 431 can activate respective spatial filters one after another. The CED 430 further includes an interface 436 for receiving and/or transmitting signals on an auxiliary radio channel. The interface 436 may be a wireless interface. In some examples, the auxiliary radio channel may be replaced with a wired auxiliary channel and the interface 436 may be a wired interface. There is a memory 432 and the processor 431 can load program code from the non-volatile memory and execute the program code. Executing the program code causes the processor to perform techniques as described herein.

FIG. 4 is only one example implementation of a CED. Other implementations are conceivable. For example, a meta-material surface not including distinct antenna elements may be used. The meta-material can have a configurable refraction index. To provide a reconfigurable refraction index, the meta-material may be made of repetitive tunable structures that have extensions smaller than the wavelength of the incident RF signals.

FIG. 5 illustrates communication between an AN 501 and a UE 503 via a CED 502. The direct (i.e., line-of-sight) directions between the AN 501 and the CED 502, and the CED 502 and the UE 503 are indicated with arrows 511 and 512, respectively.

In said scenario, the AN 501 may act as an ON and control the CED 502 to toggle through different filters associated with wide beams 521, 522, 523, wherein for each filter a pilot signal is communicated between the AN 501 and the UE 503 via the CED 502. The filters may be associated with wide beams 521, 522, 523. The strongest of the measured pilot signals may be associated with the wide beam 522. However, as shown in FIG. 5, the direction of the wide beam 522 may not perfectly align with the direct direction from the CED 502 to the UE 503. Thus, while the wide beam 522 may allow for data communication between the AN 501 and the UE 503 via the CED 502, there may be room for improvement.

In order to keep the time required for the beam sweep reasonably short and to allow for data communication between the communication nodes, only a limited number of different filters can be tested. For example, a codebook comprising a limited number of precoders may be used facilitate data communication. This may imply that a working but not optimal filter is selected to be applied by the CED 502.

The CED 502 may be implemented as a phased array. Thus, the phase shifted signals from all antennas of the CED may be combined to achieve an array gain (i.e., spatial filtering). A small portion of the received signal may be tapped to a detector, e.g. a power sensor. Thus, the CED 502 may detect the power received from a certain direction without having to demodulate an incident signal.

The CED 502 may select a candidate filter of set of candidate filters corresponding to beams 531, 532, 533 including a center filter corresponding to beam 532, wherein an input spatial direction associated with the center filter 532 corresponds to an input spatial direction of the filter associated with the wide beam 522.

The beams 531, 532, 533 may have a smaller beam width than the wide beam 522. The CED 502 may autonomously determine and compare the received average power for each beam 531, 532, 533 without significantly influencing the data communication between the AN 501 and the UE 503. The CED 502 may determine that the received average power for beam 533 is higher than for beam 532 having the same input spatial direction as beam 522. In particular, beam 533 may be better aligned with the actual direction 512 from the CED 502 to the UE 503.

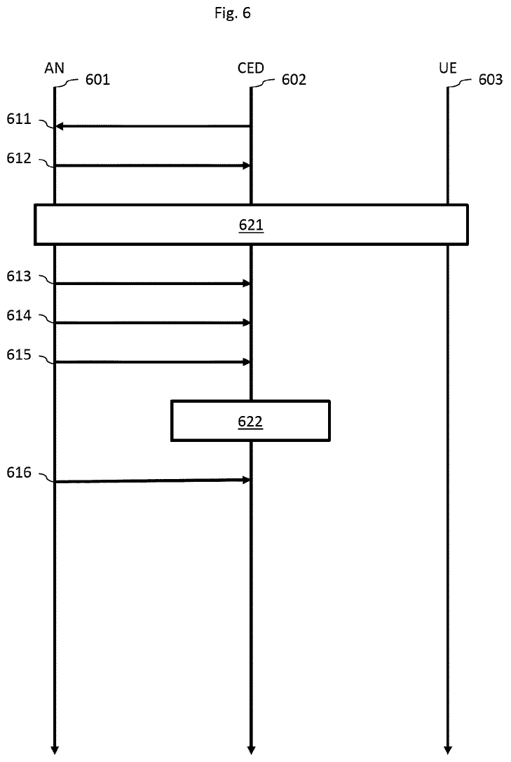

FIG. 6 illustrates signaling between the ON, which may be implemented by an AN 601, and a CED 602 to improve communication between the AN 601 and a UE 603. The CED 602 may provide a message 611 indicative of a capability of the CED 602 to enter an autonomous filter optimization mode 662. The ON 601 may obtain the message 611 indicative of a capability of the CED 602 to enter an autonomous filter optimization mode 622. The ON 601 may provide a message 612, to the CED 602, triggering the CED 602 to enter a controlled filter optimization mode. The CED 602 may obtain the message 612 and enter the controlled filter optimization mode 621. During the controlled filter optimization mode 621 the CED 602 may apply filters according to a codebook. The AN 601 and the UE 603 may communicate reference signals between each other. The CED 602 may obtain a message 613 triggering the CED 602 to leave the controlled filter optimization mode 621. The ON 601 may provide, to the CED 602, a message 614 indicative of an initial filter to be applied by the CED 602. For example, the initial filter may be determined by the ON 601 based on a reception property of reference signals communicated between the AN 601 and the UE 603. The initial filter may be determined after a beam sweep operation. The CED 602 may obtain, in particular from the ON 601, a message 615 triggering the CED 602 to enter an autonomous filter optimization mode 622. The message 614 triggering the CED 602 to enter an autonomous filter optimization mode 622 may be indicative of a parameter of the autonomous filter optimization mode. In some scenarios, the message 614 may indicate the beam width of the filters to be applied during the autonomous filter optimization mode 622. The message 614 triggering the CED 602 to enter an autonomous filter optimization mode 622 may be indicative of a time schedule for entering the autonomous filter optimization mode 622. The time schedule may prescribe periodically or semi-periodically entering the autonomous filter optimization mode 622. The CED 602 may further obtain a message 616 triggering the CED 602 to leave the autonomous filter optimization mode 622. In some examples, the message 614 may be indicative of a center filter of a set of candidate filters to be used for the autonomous filter optimization mode. In other examples, the center filter may be inferred from the chosen initial filter.

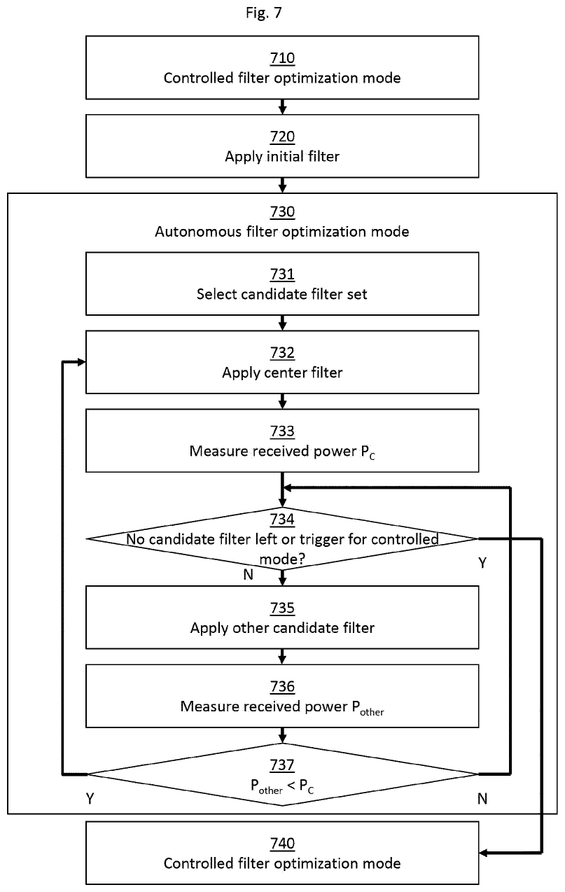

FIG. 7 further illustrates a method of operating a CED. A controlled filter optimization mode 710 may result in the CED applying an initial filter 720. Afterwards, the CED may enter an autonomous filter optimization mode 730. In particular, the CED may enter an autonomous filter optimization mode 730 upon receiving an indication to do so from the communication network. When entering the autonomous filter optimization mode 730, the CED may select 731 a candidate filter set of candidate filters. The candidate filter set comprises a center filter. The CED may apply the center filter at 732 and measure the received power Pc at 733.

Further, the CED may determine, if there are further candidate filters of the set of candidate filters at 734. If that is not the case, the CED may return to operating in a controlled filter optimization mode 740. Alternatively or in addition, the CED may check whether it has received a message to return to the filter optimization mode and switch to operating in the controlled filter optimization mode 740. At 735, the CED may apply another candidate filter of the set of candidate filters. The CED may measure the received power Pₒₜₕₑᵣ of the other candidate filter at 736. At 737, the CED may determine whether the received power Pₒₜₕₑᵣ is smaller than the received power P_{C}. If yes, the CED may decide to continue applying the center filter. If not, the CED may determine to apply the other candidate filter. In some scenarios, the CED could also measure the received power Pₒₜₕₑᵣ for each candidate filter of the set of candidate filters before deciding on the filter to apply.

Accordingly, an overhead for controlling the CED may be substantially reduced.

Summarizing, at least the following EXAMPLES have been described above:

Example 1. A method of operating a coverage enhancing device, CED, (602) wherein the CED (602) provides reconfigurable filters for incident signals received along an input spatial direction on a radio channel and transmitted as outgoing signals into an output spatial direction, the method comprising:
obtaining a message (614) indicative of an initial filter to be applied by the CED (602),
obtaining, in particular from an operator node, ON, a message (615) triggering the CED (602) to enter an autonomous filter optimization mode (622).

Example 2. The method of operating the CED (602) of example 1, wherein the message (614) triggering the CED (602) to enter an autonomous filter optimization mode (622) is indicative of a parameter of the autonomous filter optimization mode.

Example 3. The method of operating the CED (602) of example 1 or 2, wherein the message (614) triggering the CED (602) to enter an autonomous filter optimization mode (622) is indicative of a time schedule for entering the autonomous filter optimization mode (622).

Example 4. The method of operating the CED (602) of example 3, wherein the time schedule prescribes periodically or semi-periodically entering the autonomous filter optimization mode (622).

Example 5. The method of operating the CED (602) of any one of examples 1 to 4, further comprising:
providing a message (611) indicative of a capability of the CED (602) to enter an autonomous filter optimization mode (622).

Example 6. The method of operating the CED (602) of examples 1 to 5, further comprising,
obtaining a message (616) triggering the CED (602) to leave the autonomous filter optimization mode (622).

Example 7. The method of operating the CED (602) of examples 1 to 6, further comprising:
obtaining a message (612) triggering the CED (602) to enter a controlled filter optimization mode (621).

Example 8. The method of operating the CED (602) of any one of examples 1 to 7, wherein operating the CED in an autonomous filter optimization mode (622) comprises:
selecting a set of candidate filters including a center filter, wherein an input spatial direction of the center filter corresponds to an input spatial direction of the initial filter;
measuring an average received power of incident signals for each candidate filter;
applying the candidate filter with the highest average received power.

Example 9. The method of operating the CED (602) of example 8, further comprising
selecting the candidate filter with the highest average received power as new initial filter.

Example 10. A method of operating an operator node, ON, (601) wherein the operator node (601) is configured for controlling a coverage enhancing device, CED, (602),
wherein the CED (602) provides reconfigurable filters for incident signals received along an input spatial direction on a radio channel and transmitted as outgoing signals into an output spatial direction, the method comprising:
   providing, to the CED (602), a message (615) triggering the CED (602) to enter an autonomous filter optimization node (622).

1. A method of operating a coverage enhancing device, wherein the CED provides reconfigurable filters for incident signals received along an input spatial direction on a radio channel and transmitted as outgoing signals into an output spatial direction, the method comprising:
obtaining a message indicative of an initial filter to be applied by the CED,
obtaining, in particular from an operator node (ON), a message triggering the CED to enter an autonomous filter optimization mode.

2. The method of operating the CED of claim 1, wherein the message triggering the CED to enter an autonomous filter optimization mode is indicative of a parameter of the autonomous filter optimization mode.

3. The method of operating the CED of claim 1, wherein the message triggering the CED to enter an autonomous filter optimization mode is indicative of a time schedule for entering the autonomous filter optimization mode.

4. The method of operating the CED of claim 3, wherein the time schedule prescribes periodically or semi-periodically entering the autonomous filter optimization mode.

5. The method of operating the CED of claim 1, further comprising:
providing a message indicative of a capability of the CED to enter an autonomous filter optimization mode.

6. The method of operating the CED of claim 1, further comprising,
obtaining a message triggering the CED to leave the autonomous filter optimization mode.

7. The method of operating the CED of claim 1, further comprising:
obtaining a message triggering the CED to enter a controlled filter optimization mode.

8. The method of operating the CED of claim 7, further comprising:
obtaining a message triggering the CED to leave the controlled filter optimization mode.

9. The method of operating the CED of claim 1, wherein operating the CED in an autonomous filter optimization mode comprises:
selecting a set of candidate filters including a center filter, wherein an input spatial direction of the center filter corresponds to an input spatial direction of the initial filter;
measuring an average received power of incident signals for each candidate filter;
applying the candidate filter with the highest average received power.

10. The method of operating the CED of claim 9, further comprising
selecting the candidate filter with the highest average received power as new initial filter.

11. A method of operating an operator node ON, wherein the operator node is configured for controlling a coverage enhancing device (CED), wherein the CED provides reconfigurable filters for incident signals received along an input spatial direction on a radio channel and transmitted as outgoing signals into an output spatial direction, the method comprising:
providing, to the CED, a message triggering the CED to enter an autonomous filter optimization node.

12. The method of operating the ON of claim 11, further comprising
providing, to the CED, a message indicative of an initial filter to be applied by the CED.

13. The method of operating the ON of claim 11, wherein the message triggering the CED to enter an autonomous filter optimization mode is indicative of a parameter of the autonomous filter optimization mode.

14. The method of operating the ON of claim 11, wherein the message triggering the CED to enter an autonomous filter optimization mode is indicative of a time schedule for entering the autonomous filter optimization mode.

15. The method of operating the ON of claim 14, wherein the time schedule prescribes periodically or semi-periodically entering the autonomous filter optimization mode.

16. The method of operating the ON of claim 11, further comprising
providing, to the CED, a message triggering the CED to leave the autonomous filter optimization node.

17. The method of operating the ON of claim 11, further comprising
obtaining a message indicative of a capability of the CED to enter an autonomous filter optimization mode.

18. The method of operating the ON of claim 11, further comprising
providing, to the CED, a message triggering the CED to leave the autonomous filter optimization mode.

19. The method of operating the ON of claim 11, further comprising
providing, to the CED, a message triggering the CED to enter a controller filter optimization mode.

20. The method of operating the ON of claim 19, further comprising
providing, to the CED, a message triggering the CED to leave the controlled filter optimization mode.

21-22. (canceled)
